(19) United States
(12) Patent Application Publication
(10) Pub. No.: US 2022/0375637 A1
(43) Pub. Date: Nov. 24, 2022

(54) CONTAINMENT APPARATUS MONITORING SYSTEM AND METHOD

(71) Applicant: INDUSTRIAL COOPERATION FOUNDATION JEONBUK NATIONAL UNIVERSITY, Jeonju-si (KR)

(72) Inventors: Hee SEO, Jeonju-si (KR); Jihyun AHN, Jeonju-si (KR); Sangyong KIM, Daejeon (KR); Jungki SHIN, Daejeon (KR)

(21) Appl. No.: 17/880,137

(22) Filed: Aug. 3, 2022

Related U.S. Application Data
(63) Continuation-in-part of application No. PCT/KR2021/001676, filed on Feb. 9, 2021.

(30) Foreign Application Priority Data
Nov. 4, 2020 (KR) 10-2020-0146086

(51) Int. Cl. G21C 17/00; G21C 17/017; G01S 19/17

(52) U.S. Cl. CPC G21C 17/002; G21C 17/017; G01S 19/17

(57) ABSTRACT

Provided are containment apparatus monitoring system and method. The containment apparatus monitoring system includes at least one containment apparatus configured to contain nuclear material and generate containment information including integrity information and radiation information, a converter configured to collect the containment information from the containment apparatus, and a control server configured to analyze integrity of the nuclear material and a radiation state in the containment apparatus by using the containment information collected from the converter and monitor whether the containment apparatus is abnormal by using the analyzed result.

### CROSS-REFERENCE TO RELATED APPLICATION(S)

The present application is a continuation-in-part of international patent application No. PCT/KR2021/001676 filed on Feb. 9, 2021, and claims priority to Korean patent application No. 10-2020-0146086 filed on Nov. 4, 2020, the entire contents of which are hereby incorporated by reference.

### STATEMENT REGARDING PRIOR DISCLOSURES BY THE INVENTOR OR A JOINT INVENTOR

A disclosure entitled “TECHNOLOGY DEVELOPMENT OF CONTAINMENT CONTAINERS FOR REAL TIME VERIFICATION OF SENSITIVE NUCLEAR MATERIALS” disclosed on or around Apr. 28, 2020, is a prior disclosure made by a joint inventor, and the disclosure does not qualify as prior art under the exception provided under 35 USC 102(b)(1). A copy of the disclosure is submitted herewith in an information disclosure statement.

### TECHNICAL FIELD

The present invention relates to a containment apparatus monitoring system, and more particularly, to containment apparatus monitoring system and method for remotely monitoring a containment apparatus in real time.

### BACKGROUND

For the peaceful use of nuclear energy, the international community has signed a safeguards agreement and fulfills international obligations according thereto. Containment and monitoring are parts of the safeguarding activity.

A key aspect of containment technology is to maintain continuity of knowledge (CoK). To this end, a containment apparatus is attached to a container in which nuclear material verified by an inspector of the international organization IAEA is contained, and continuity of knowledge is verified through a simple verification method.

However, in the related art, it is difficult to respond immediately in the event of extortion of nuclear material, loss of continuity of knowledge, and other similar situations because only direct verification may be made by visiting the site. That is, there is a problem in that, when the containment apparatus is damaged, damage information may not be checked until a user visits the site.

### SUMMARY OF INVENTION

### Technical Problem

An object of the present invention is to provide containment apparatus monitoring system and method for remotely monitoring a containment state of a containment apparatus in real time to support immediate response in an emergency situation.

### Solution to Problem

In order to achieve the object, a containment apparatus monitoring system according to the present invention includes at least one containment apparatus configured to contain nuclear material and generate containment information including integrity information and radiation information, a converter configured to collect the containment information from the containment apparatus, and a control server configured to analyze integrity of the nuclear material and a radiation state in the containment apparatus by using the containment information collected from the converter and monitor whether the containment apparatus is abnormal by using the analyzed result.

The containment apparatus may check tampered record including at least one of a tampered date, a tampered time, and a tampered attempt record by using an optical fiber wire installed therein and verify the integrity information by using the tampered record.

The containment apparatus may measure radiation information by using gas or scintillation in the containment apparatus based on a radiation meter installed therein.

The containment apparatus may encrypt the containment information and transmit the encrypted containment information to the converter through LoRa communication.

The containment apparatus may receive global positioning system (GPS) information, include the received GPS information in the containment information, and transmit the containment information to the converter.

The control server may generate an alarm signal when the containment apparatus is abnormal and output the generated alarm signal.

The containment apparatus monitoring system may further include a user terminal configured to communicate with the control server, receive monitored information from the control server, and output the received information.

A containment apparatus monitoring method according to the present invention includes generating, by using at least one containment apparatus, containment information including integrity information and radiation information, collecting, by a converter, the containment information from the containment apparatus, analyzing, by a control server, integrity of nuclear material and a radiation state in the containment apparatus by using the containment information collected from the converter, and monitoring, by the control server, whether the containment apparatus is abnormal by using the analyzed result.

### Advantageous Effects

The containment apparatus monitoring system and method of the present invention may remotely monitor a containment state of a containment apparatus in real time by using an optical fiber wire and a radiation meter in the containment apparatus.

Through this, a user may reduce radiation exposure while simultaneously controlling the nuclear material and responding to an emergency situation in real time.

In addition, unlike the related art, continuity of knowledge may be maintained by monitoring a change in radiation information to continuously acquire additional information by using a radiation meter even when a containment apparatus fails.

### BRIEF DESCRIPTION OF THE DRAWINGS

FIG. 1 is a configuration diagram illustrating a containment apparatus monitoring system according to an embodiment of the present invention.

FIG. 2 is a block diagram illustrating a containment apparatus according to an embodiment of the present invention.

FIG. 3 is a block diagram illustrating a control server according to an embodiment of the present invention.

FIG. 4 is a flowchart illustrating a containment apparatus monitoring method according to an embodiment of the present invention.

### BEST MODE FOR INVENTION

Hereinafter, embodiment of the present invention will be described in detail with reference to the accompanying drawings. First, in adding reference numerals to the components of each drawing, the same components are given the same reference numerals as much as possible even when the components are illustrated in different drawings. In addition, in describing the present invention, when it is determined that a detailed description of a related known configuration or function is obvious to those skilled in the art or may obscure the gist of the present invention, detailed descriptions thereof are omitted.

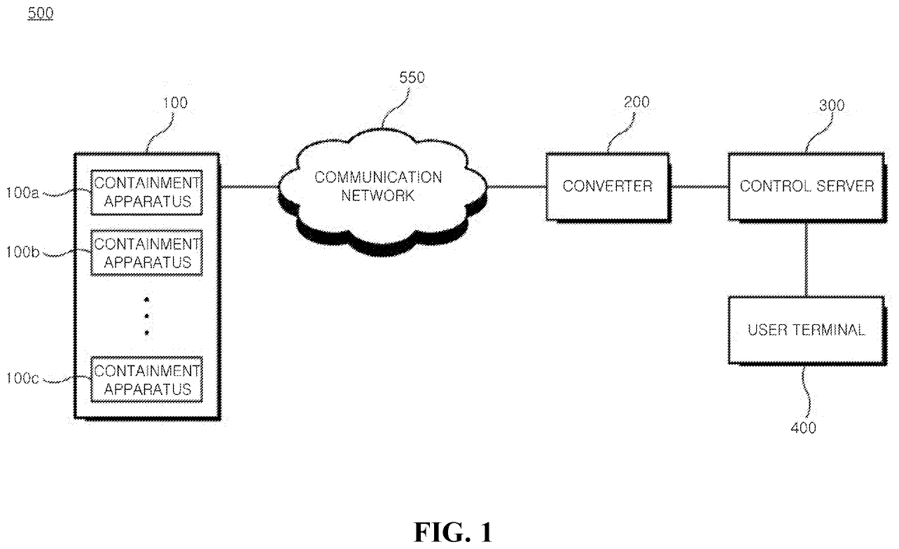

FIG. 1 is a configuration diagram illustrating a containment apparatus monitoring system according to an embodiment of the present invention.

Referring to FIG. 1, a containment apparatus monitoring system 500 remotely monitors a containment state of a containment apparatus in real time to support an immediate response in an emergency situation. The containment apparatus monitoring system 500 includes the containment apparatus 100, a converter 200, and a control server 300 and further includes a user terminal 400.

The containment apparatus 100 contains nuclear material. For example, the containment apparatus 100 may be installed in a heavy water-spent nuclear fuel dry storage facility to contain spent nuclear fuel. There may be provided one or more containment apparatuses 100a, 100b, and 100c. The containment apparatus 100 contains nuclear material and also measures containment information including integrity information of the nuclear material and internal radiation information. Through this, a state of the containment apparatus 100 may be remotely checked in real time.

The converter 200 collects conversion information measured from at least one containment apparatus 100. That is, the converter 200 serves to mediate communication between the containment apparatus 100 and the control server 300. Here, the converter 200 may perform communication with the containment apparatus 100 through LoRa (long range) communication suitable for wireless communication that consumes little power and does not have a large amount of data but is not limited thereto.

The control server 300 analyzes integrity of the nuclear material and a radiation state in the containment apparatus by using the containment information collected from the converter 200. The control server 300 monitors whether the containment apparatus is abnormal by using the analyzed result. At this time, when an abnormal containment apparatus is detected, the control server 300 generates an alarm signal for the containment apparatus and outputs the generated alarm signal. The control server 300 may be a computer system such as a desktop computer, a server computer, a cluster computer, or so on.

The user terminal 400 communicates with the control server 300 and receives monitored information from the control server 300. The user terminal 400 may filter the received information in a form desired by a user and then output the corresponding information. Here, when the monitored information includes information on an abnormal containment apparatus, the user terminal 400 may output a current state and an alarm message for the containment apparatus. In addition, the user terminal 400 may transmit a user input to the control server 300 to receive information desired by the user.

Meanwhile, the containment apparatus monitoring system 500 further includes a communication network 550 to support communication between respective components. In the drawing, the communication network 550 is illustrated as being provided between the containment apparatus 100 and the converter 200 but may be provided between the control server 300 and the user terminal 400 without being limited thereto. The communication network 550 may be composed of a backbone network and a subscriber network. The backbone network may be composed of one of an X.25 network, a frame relay network, an ATM network, a multi protocol label switching (MPLS) network, and a generalized multi protocol label switching (GMPLS) network, or a plurality of integrated networks thereof. The subscriber network may be fiber to the home (FTTH), an asymmetric digital subscriber line (ADSL), a cable network, Zigbee, Bluetooth, wireless LAN (IEEE 802.11b, IEEE 802.11a, IEEE 802.11g, IEEE 802.11n), wireless hart (ISO/IEC62591-1), ISA100.11a (ISO/IEC 62734), a constrained application protocol (COAP), multi-client publish/subscribe messaging (MQTT), wireless broadband (WIBro), long range (Lora), Wimax, 3G, high speed downlink packet access (HSDPA), 4G, or 5G. In some embodiments, the communication network 550 may be an Internet network or a mobile communication network. In addition, the communication network 550 may include any other wireless communication method or wired communication method that are well-known or to be developed in the future.

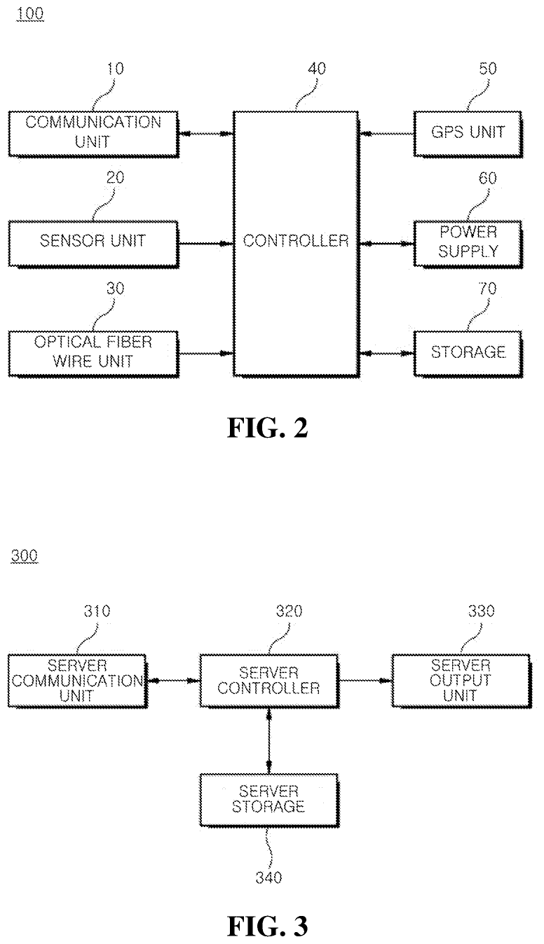

FIG. 2 is a block diagram illustrating a containment apparatus according to an embodiment of the present invention.

Referring to FIGS. 1 and 2, the containment apparatus 100 includes a communication unit 10, a sensor unit 20, an optical fiber wire unit 30, a controller 40, a global positioning system (GPS) unit 50, a power supply 60, and a storage 70.

The communication unit 10 communicates with the converter 200. The communication unit 10 transmits containment information to the converter 200. At this time, the communication unit 10 may transmit the communication information through LoRa communication but is not limited thereto.

The sensor unit 20 measures radiation information by sensing a radiation state in the containment apparatus. To this end, the sensor unit 20 may be a radiation meter such as a gas detector or a scintillation detector. That is, when radiation is incident on the radiation meter, the radiation reacts with gas or scintillator, and the sensor unit 20 may measure the amount of radiation by collecting ions or light generated by the reaction.

The optical fiber wire unit 30 is configured with a wire formed of an optical fiber and is provided at a position adjacent to a position in which nuclear material is contained. The optical fiber wire unit 30 checks tampered record including at least one of a tampered date, a tampered time, and a tampered attempt record by using an optical fiber wire. For example, when a container containing the nuclear material is stolen, the optical fiber wire unit 30 may record date, time, and so on of which information is stolen and tampered by using the fiber optic wire as tampered record. The optical fiber wire unit 30 verifies integrity information by using the tampered record. That is, the optical fiber wire unit 30 may verify that integrity of the integrity information is not appropriate when the tampered record is made. Here, the integrity information indicates information that constantly maintains normal data guarantee such that data information is not changed or omitted.

The controller 40 controls driving of the containment apparatus 100. The controller 40 generates containment information including information measured by the sensor unit 20 and the optical fiber wire unit 30. The controller 40 transmits the generated containment information to the converter 200. Also, the controller 40 may include GPS information in the containment information. Through this, the controller 40 may support the control server 300 to check a position of the containment apparatus by using only the containment information. The controller 40 may encrypt the generated containment information such that only a preset user may check corresponding information, and thus, security may be enhanced.

The GPS unit 50 receives GPS information on which a containment apparatus is currently located. The GPS unit 50 may map a position on a map or a drawing based on the received GPS information and transmit the mapped information to the controller 40. Here, the containment apparatus 100 may use an RF module instead of the GPS unit 50 in a case of an indoor environment.

The power supply 60 supplies power to the containment apparatus 100. The power supply 60 may supply the power in various forms but preferably may supply the power in the form of a battery. In addition, the power supply 60 may additionally supply power using renewable energy such as solar thermal energy and wind energy.

The storage 70 stores a program or algorithm for driving the containment apparatus 100. The storage 70 stores containment information. The storage 70 may include at least one storage medium among a flash memory type, a hard disk type, a multimedia card micro type, a card type memory (for example, SD or XD memory, or so on), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

FIG. 3 is a block diagram illustrating a control server according to an embodiment of the present invention.

Referring to FIGS. 1 and 3, the control server 300 includes a server communication unit 310, a server controller 320, a server output unit 330, and a server storage 340.

The server communication unit 310 communicates with the converter 200 and the user terminal 400. The server communication unit 310 receives containment information collected from the converter 200 and receives a user input from the user terminal 400. The server communication unit 310 transmits the monitored information to the user terminal 400.

The server controller 320 analyzes integrity of nuclear material and a radiation state in the containment apparatus 100 by using the received containment information. The server controller 320 checks tampered record by using the integrity information included in the containment information, determines that there is abnormality when there is tampered record, and determines that there is no abnormality when there is no tampered record. Also, the server controller 320 determines the radiation state in the containment apparatus by using the radiation information included in the containment information. The server controller 320 estimates and monitors whether the containment apparatus is abnormal and a current state by using the determined result.

For example, the server controller 320 may transmit optical pulses at a cycle of about 240 ms to about 260 ms, determine that the containment is released and an optical fiber wire is damaged or cut when the pulses are not received, determine that the containment apparatus is opened when an outer housing of the containment apparatus 100 is opened without approval, determine that there is a communication failure when communication is not performed once a day or there is no response, and determine that the containment apparatus 100 moves to a non-reported position when the containment apparatus 100 moves to an unapproved position outside a building or the change in the position of the apparatus exceeds a predetermined criterion.

In this case, the server controller 320 may divide the monitored result into a plurality of states. That is, the server controller 320 may divide the result into states such as a normal state, a caution state, and a dangerous state but the states are not limited thereto. For example, the server controller 320 may classify the state as a caution state when there is tampered record and a radiation state in the containment apparatus is normal and classify the state as a dangerous state when there is tampered record and the radiation state in the containment apparatus is unstable.

The server output unit 330 matches a result analyzed by the server controller 320 with a preset format and outputs the matched result. In addition, although not illustrated in the drawing, the server output unit 330 may receive a user input from a manager and output an analysis result according to the user input.

The server storage 340 stores a program or algorithm for driving the control server 300. The server storage 340 stores the analysis result received from the server controller 320. The server storage 340 may include at least one storage medium among a flash memory type, a hard disk type, a multimedia card micro type, a card type memory (for example, SD or XD memory, or so on), a RAM, an SRAM, a ROM, an EEPROM, a PROM, a magnetic memory, and a magnetic disk optical disk.

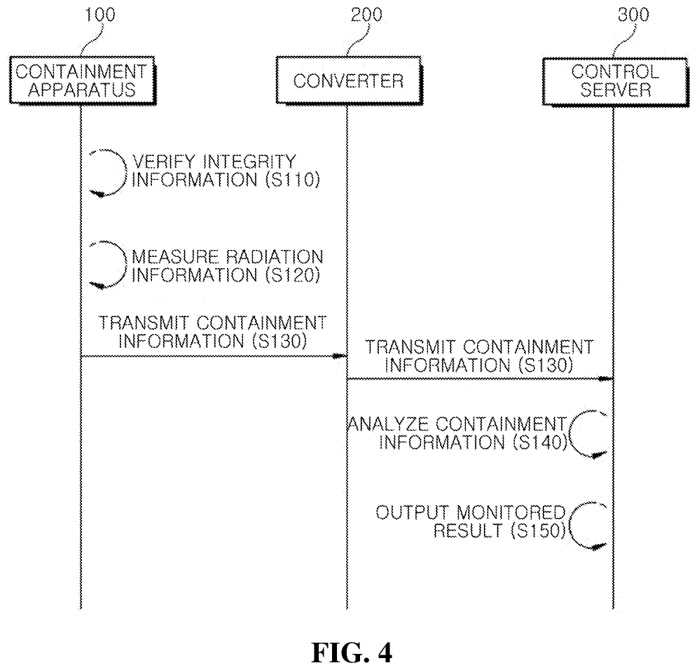

FIG. 4 is a flowchart illustrating a containment apparatus monitoring method according to an embodiment of the present invention.

Referring to FIG. 4, the containment apparatus monitoring method may remotely monitor a containment state of a containment apparatus in real time through an optical fiber wire and a radiation meter included in the containment apparatus. Through this, a user may reduce radiation exposure while simultaneously responding to nuclear material control and an emergency situation in real time. In addition, unlike the related art, continuity of knowledge may be maintained by monitoring a change in radiation information to continuously acquire additional information by using the radiation meter even when a containment apparatus fails.

In step S110, the containment apparatus 100 verifies integrity information. The containment apparatus 100 checks tampered record including at least one of a tampered date, a tampered time, and a tampered attempt record by using an optical fiber wire. The containment apparatus 100 verifies the integrity information by using the checked tampered record. That is, the containment apparatus 100 may measure that integrity of the integrity information is not appropriate when the tampered record is made.

In step S120, the containment apparatus 100 measures radiation information. The containment apparatus 100 measures the radiation information by sensing a radiation state in the containment apparatus. To this end, the containment apparatus 100 may include a radiation meter such as a gas detector or a scintillation detector. That is, when radiation is incident on the radiation meter, the radiation reacts with gas or scintillator, and the containment apparatus 100 may measure the amount of radiation by collecting ions or light generated by the reaction.

In step S130, the containment apparatus 100 transmits containment information including the integrity information and the radiation information to the converter 200, and the converter 200 transmits the containment information to the control server 300. Here, the containment apparatus 100 encrypts the containment information such that only a preset user may check corresponding information, and thus, security may be enhanced.

In step S140, the control server 300 analyzes the containment information. The control server 300 analyzes integrity of nuclear material and a radiation state in the containment apparatus 100 by using the received containment information. The control server 300 checks tampered record by using the integrity information included in the containment information, determines that there is abnormality when there is tampered record in the tampered record, and determines that there is no abnormality when there is no tampered record. In addition, the control server 300 determines the radiation state in the containment apparatus by using the radiation information included in the containment information. The control server 300 estimates and monitors whether the containment apparatus is abnormal and a current state by using the determined result.

In step S150, the control server 300 outputs a monitored result. The control server 300 matches the analyzed result with a preset format and outputs matched result. The control server 300 may receive a user input from a manager and output an analysis result according to the user input.

The method according to an embodiment of the present invention may be provided in the form of computer-readable recording media suitable for storing computer program instructions and data. The computer-readable recording media may include program instructions, data files, data structures, or so on or combinations thereof and include all types of recording devices in which data readable by a computer system is stored. The computer-readable recording media include, for example, magnetic media such as hard disks, floppy disks, or magnetic tapes, optical media such as a compact disk read only memory (CD-ROM) and a digital video disk (DVD), magneto-optical media such as floptical disks, and hardware devices, which are specially configured to store and execute program commands, such as a read only memory (ROM), a random access memory (RAM), and a flash memory. In addition, the computer-readable recording media may be distributed in a computer systems connected to each other through a network to store and execute computer-readable codes in a distributed manner. In addition, functional programs, codes, and code segments for implementing the present invention may be easily inferred by programmers in the technical field to which the present invention pertains.

The term “unit” is defined herein as having its broadest definition to ordinary skill in the art to refer to software including instructions executable in a non-transitory computer-readable medium that would perform the associated function when executed, a circuit designed to perform the associated function, hardware designed to perform the associated function, or a combination of software, a circuit, or hardware designed to perform the associated function.

Further, it is to be understood that all detailed descriptions mentioning specific embodiments of the present disclosure as well as principles, aspects, and embodiments of the present disclosure are intended to include structural and functional equivalences thereof. Further, it is to be understood that these equivalences include an equivalence that will be developed in the future as well as an equivalence that is currently well-known, that is, all elements invented so as to perform the same function regardless of a structure.

Therefore, it is to be understood that, for example, block diagrams of the present specification illustrate a conceptual aspect of an illustrative circuit for embodying a principle of the present disclosure. Therefore, it is to be understood that all flow charts, state transition diagrams, pseudo-codes, and the like, illustrate various processes that may be tangibly embodied in a computer-readable medium and that are executed by computers or processors regardless of whether or not the computers or the processors are clearly illustrated.

Functions of various elements including processors or functional blocks represented as concepts similar to the processors and illustrated in the accompanying drawings may be provided using hardware having capability to execute software in connection with appropriate software as well as dedicated hardware. When the functions are provided by the processors, they may be provided by a single dedicated processor, a single shared processor, or a plurality of individual processors, and some of them may be shared with each other.

In addition, the explicit use of terms presented as the processor, control, or similar concepts should not be interpreted exclusively by quoting hardware capable of executing software, but should be understood to implicitly include, without limitation, digital signal processor (DSP) hardware, a ROM for storing software, a RAM, and a non-volatile memory. The above-mentioned terms may also include well-known other hardware.

In the claims of the present specification, components represented as means for performing functions mentioned in a detailed description are intended to include all methods for performing functions including all types of software including, for example, a combination of circuit devices performing these functions, firmware/micro codes, or the like, and are coupled to appropriate circuits for executing the software so as to execute these functions. It is to be understood that since functions provided by variously mentioned means are combined with each other and are combined with a method demanded by the claims in the present disclosure defined by the claims, any means capable of providing these functions are equivalent to means recognized from the present specification.

As described above, although preferred embodiments for the technical ideas of the present invention are described and shown, the present invention is not limited to the configurations and operations as shown and described as such, and it will be apparent to those skilled in the art that many changes and modifications may be made to the present invention without departing from the scope of the technical idea. Accordingly, it should be considered that all the suitable changes, modifications, and equivalents are within the scope of the present invention.

### REFERENCES LIST

10: communication unit 20: sensor unit

30: optical fiber wire unit 40: controller

50: GPS unit 60: power supply

70: storage 100: containment apparatus

200: converter 300: control server

310: server communication unit 320: server controller

330: server output unit 340: server storage

400: user terminal 500: containment apparatus monitoring system

550: communication network

1. A containment apparatus monitoring system comprising:
at least one containment apparatus configured to contain nuclear material and generate containment information including integrity information of the nuclear material and radiation information of the containment apparatus;
a converter configured to collect the containment information from the containment apparatus; and
a control server configured to analyze integrity of the nuclear material and a radiation state in the containment apparatus by using the containment information collected by the converter and determine whether the containment apparatus is abnormal by using the analyzed result.

2. The containment apparatus monitoring system of claim 1, wherein
the containment apparatus checks a tampered record including at least one of a tampered date, a tampered time, and a tampered attempt record by using an optical fiber wire installed therein and verifies the integrity information by using the tampered record.

3. The containment apparatus monitoring system of claim 1, wherein
the containment apparatus measures the radiation information by using gas or scintillation in the containment apparatus based on a radiation meter installed therein.

4. The containment apparatus monitoring system of claim 1, wherein
the containment apparatus encrypts the containment information and transmits the encrypted containment information to the converter through long range (LoRa) communication.

5. The containment apparatus monitoring system of claim 1, wherein
the containment apparatus receives global positioning system (GPS) information, includes the received GPS information in the containment information, and transmits the containment information to the converter.

6. The containment apparatus monitoring system of claim 1, wherein
the control server generates an alarm signal when the containment apparatus is abnormal and outputs the generated alarm signal.

7. The containment apparatus monitoring system of claim 1, further comprising:
a user terminal configured to communicate with the control server, receive monitored information from the control server, and output the received monitored information.

8. A containment apparatus monitoring method comprising:
generating, by using at least one containment apparatus configured to contain nuclear material, containment information including integrity information of the nuclear material and radiation information of the containment apparatus;
collecting, by a converter, the containment information from the containment apparatus;
analyzing, by a control server, integrity of the nuclear material and a radiation state in the containment apparatus by using the containment information collected by the converter; and
monitoring, by the control server, to determine whether the containment apparatus is abnormal by using the analyzed result.
